(19) United States
(12) Patent Application Publication
(10) Pub. No.: US 2003/0099234 A1
(43) Pub. Date: May 29, 2003

(54) Multi-point communication method

(76) Inventors: Yuji Horii, Tokyo (JP); Shu Murayama, Tokyo (JP); Hiroshi Honma, Tokyo (JP); Susumu Oka, Tokyo (JP); Tokumichi Murakami, Tokyo (JP)

Correspondence Address: BIRCH STEWART KOLASCH & BIRCH, PO BOX 747, FALLS CHURCH, VA, 22040-0747, US

(21) Appl. No.: 10/204,863

(22) PCT Filed: Nov. 29, 2001
(86) PCT No.: PCT/JP01/10448

(51) Int. Cl. H04L 12/28

(52) U.S. Cl. 370/390; 370/392

(57) ABSTRACT

A call establishing control unit 6 of a communication terminal A sends a call through a transmission interface unit 5a in a bearer appropriate to multimedia communication, establishes a communication channel, sends a call through a transmission interface unit 5b in a bearer appropriate to a group of additional information and control information and establishes another communication channel. A video codec 1 and an audio codec 2 perform the multimedia communication through a multiplexing and demultiplexing unit 4 and the transmission interface unit 5a. An additional information and control information processing unit 3 performs communication of additional information and control information through the transmission interface unit 5b. Therefore, multimedia information can use the communication channels appropriate to characteristics of the multimedia information, and additional information and control information can use the communication channels appropriate to characteristics of the group of additional information and control information.

### TECHNICAL FIELD

The present invention relates to a multi-point communication method in which multimedia multi-point communication and the transmission of a group of additional information and control information relating to a communication service are performed between a communication service unit providing a multi-point communicating service and a group of communication terminals, or among the communication service unit, a communication server and a group of communication terminals or between a communication terminal, which is originally connected with a first communication service unit and is additionally connected with a second communication service unit, and the second communication service unit.

### BACKGROUND ART

FIG. 1 is a view showing the configuration of a conventional multimedia multi-point communication system. In FIG. 1, 1 indicates a video codec (coder decoder) for coding and decoding video data. 2 indicates an audio codec for coding and decoding audio data. 31 indicates a control data processing unit for performing the sending and receiving processing for a group of additional information and control information relating to a communication service. The sending and receiving processing is, for example, performed in the control data processing unit 31 for control information of a TV meeting held among members placed at many points (hereinafter, called a multi-point TV meeting). 41 indicates a multiplexing and demultiplexing unit for performing multiplexing and demultiplexing processing for the video data, the audio data and the control data. 5a indicates a transmission interface unit for functioning as an interface with a communication network. 61 indicates a call establishing control unit for establishing a communication channel and performing a disconnection from the communication channel. Each of a plurality of communication terminals A to N placed at many points has the video codec 1, the audio codec 2, the control data processing unit 31, the multiplexing and demultiplexing unit 41, the transmission interface unit 5a and the call establishing control unit 61. 51a to 51n indicate a plurality of transmission interface units for performing multimedia multi-point communication with the communication terminals A to N of many points respectively. 71a to 71n indicate a plurality of multiplexing and demultiplexing units, corresponding to the transmission interface units 51a to 51n respectively, for respectively performing media multiplexing and demultiplexing processing. 81 indicates a multimedia processing unit for performing media processing, which is appropriate to the communication terminals A to N connected to a communication service unit through the communication network, for media data demultiplexed in each of the multiplexing and demultiplexing units 71a to 71n. For example, the selection of a picture of a speaker or audio mixing processing is performed for the media data in the multimedia processing unit 81. 91 indicates an additional information and control information processing unit for performing prescribed processing or a response for a group of additional information and control information relating to a communication service. The processing or a response is, for example, performed in the additional information and control information processing unit 91 for control information of a multi-point TV meeting. 10 indicates a call establishing control unit for performing the establishing processing to establish a communication channel of the communication through each of the transmission interface units 51a to 51n. The communication service unit has the transmission interface units 51a to 51n, the multiplexing and demultiplexing units 71a to 71n, the multimedia processing unit 81, the additional information and control information processing unit 91 and the call establishing control unit 10.

Next, an operation will be described below.

For example, the communication terminal A sends a call and establishes a communication channel, and multimedia multi-point communication is performed between the communication terminal A and a group of other communication terminals of many points. This case will be described below.

An operation of the communication terminal A is initially described with reference to FIG. 1. The call establishing control unit 61 of the communication terminal A sends a call to the communication network and establishes a communication channel in a bearer type. Thereafter, in the video codec 1 and the audio codec 2 of the communication terminal A, coding processing is performed for video data and audio data, and coded media data obtained from the video data and the audio data is output to the multiplexing and demultiplexing unit 41. Also, in the control data processing unit 31, control data is produced and is output to the multiplexing and demultiplexing unit 41. In the multiplexing and demultiplexing unit 41, the coded media data and the control data are multiplexed with each other to produce multiplexed data, and the multiplexed data is output to the transmission interface unit 5a. In the transmission interface unit 5a, the multiplexed data is sent out to the communication network while using the communication channel established by the call establishing control unit 61.

Next, an operation of the communication service unit is described with reference to FIG. 1.

When a call sent from one of the communication terminals A to N is received in the corresponding transmission interface unit 51a,—, or 51n through the communication network, call receiving processing is performed in the call establishing control unit 10, and the communication channel is established. Thereafter, in the corresponding transmission interface unit 51a,—, or 51n, the multiplexed data is received through the communication channel established by the call establishing control unit 10 and is output to the corresponding multiplexing and demultiplexing unit 71a,—, or 71n. In the corresponding multiplexing and demultiplexing unit 71a,—, or 71n, the multiplexed data is demultiplexed to the media data and the control data, the media data is output to the multimedia processing unit 81, and the control data is output to the additional information and control information processing unit 91. In the multimedia processing unit 81, media processing appropriate to the communication terminals A to N connected to the communication service unit through the communication network is performed for the media data to produce pieces of processed media data. For example, the selection of a picture of a speaker or audio mixing processing is performed according to the media data. Thereafter, multiplexing processing is performed in each of the multiplexing and demultiplexing units 71a to 71n for the pieces of processed media data, and the multiplexed media data is returned to prescribed communication terminals through the corresponding transmission interface units 51a to 51n. Therefore, the communication service unit performs the multi-point communication of multimedia information with a plurality of communication terminals connected to the communication service unit through the communication network. Also, in the additional information and control information processing unit 91, prescribed processing is performed according to a group of additional information and control information relating to a communication service. The processing is, for example, performed according to control information of a multi-point TV meeting. As a response operation, processed control data is sent to a plurality of communication terminals connected to the communication service unit through the multiplexing and demultiplexing units 71a to 71n and the transmission interface units 51a to 51n.

Because the conventional multimedia multi-point communication system has the above-described configuration, the multimedia information and the group of additional information and control information relating to the communication service are multiplexed with each other and are transmitted through one communication channel. Therefore, a problem has arisen that it is impossible to select a communication channel of a bearer type appropriate to characteristics of the pieces of information and to perform the multimedia multi-point communication through the communication channel. Also, another problem has arisen that it is required to control the multimedia multi-point communication by sharing a communication band among the pieces of information.

The present invention is provided to solve the above-described problem, and the object of the present invention is to provide a multi-point communication method in which multi-point communication of multimedia information and a group of additional information and control information relating to a communication service is performed in a bearer type appropriate to characteristics of the multimedia information and a bearer type appropriate to characteristics of the group of additional information and control information at high efficiency.

### DISCLOSURE OF THE INVENTION

In a multi-point communication method according to the present invention, a plurality of communication channels are established between each of a plurality of communication terminals and a multi-point communication service unit, and contents of information transmitted on each communication channel differ from contents of information transmitted on the other communication channels.

Therefore, in cases where the communication of pieces of information such as multimedia information and a group of additional information and control information having contents different from each other is performed, a communication channel appropriate to characteristics of each piece of information can be used. Also, the control for sharing a band of a communication channel and using each shared band for the communication of one piece of information is not required. Therefore, a multi-point communication service can be provided for a plurality of communication terminals at high efficiency.

### BRIEF DESCRIPTION OF THE DRAWINGS

FIG. 1 is a view showing the configuration of a conventional multimedia multi-point communication system.

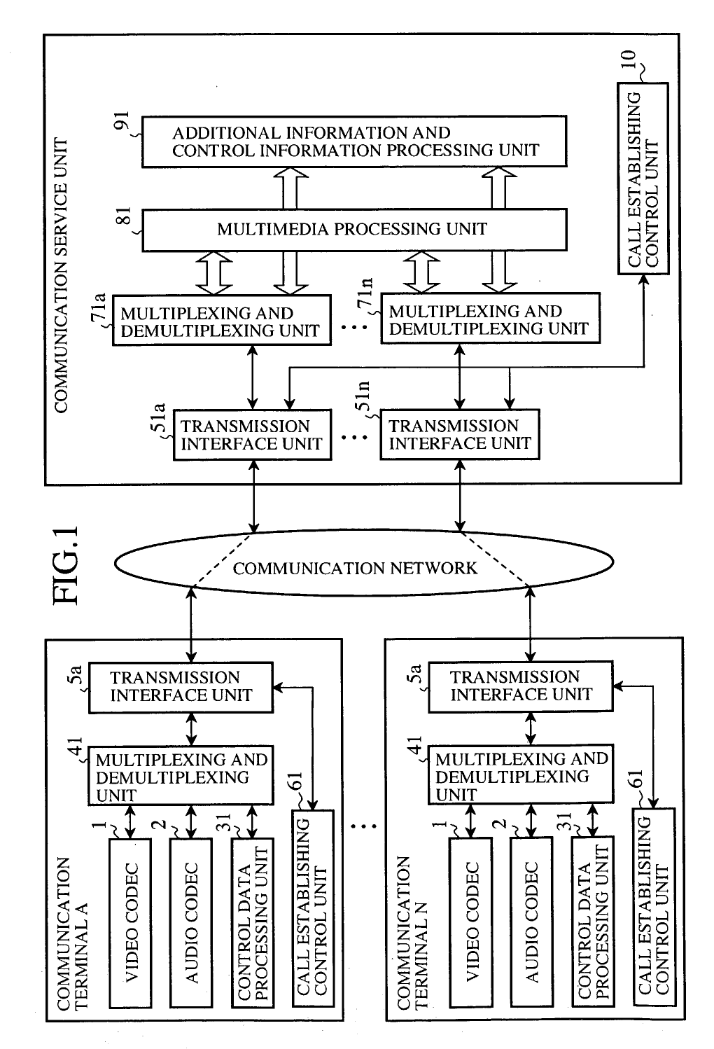

FIG. 2 is a view showing the configuration of a multimedia multi-point communication system adopting a multi-point communication method according to a first embodiment, a third embodiment and a fourth embodiment of the present invention.

FIG. 3 is a view showing the configuration of a multimedia multi-point communication system adopting a multi-point communication method according to a second embodiment of the present invention.

FIG. 4 is a view showing the configuration of a multimedia multi-point communication system adopting a multi-point communication method according to a fifth embodiment of the present invention.

### BEST MODE FOR CARRYING OUT THE INVENTION

Hereinafter, the best mode for carrying out the present invention will now be described with reference to the accompanying drawings to explain the present invention in more detail.

### EMBODIMENT 1

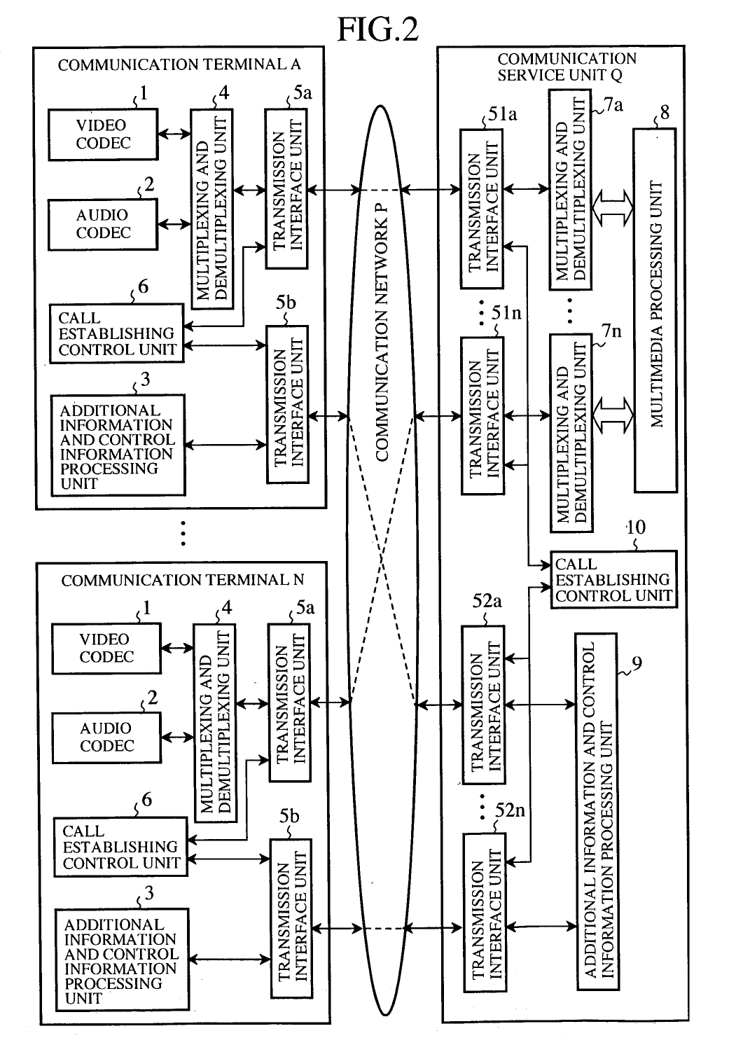

FIG. 2 is a view showing the configuration of a multimedia multi-point communication system adopting a multi-point communication method according to a first embodiment, a third embodiment and a fourth embodiment of the present invention. In FIG. 2, A to N indicate a plurality of communication terminals respectively. In this embodiment, the symbols A to N are used for convenience of explanation, and the number of communication terminals is not limited. P indicates a communication network such as an internet. Q indicates a communication service unit providing a multi-point communication service to the communication terminals A to N.

In the configuration of the communication terminals A to N shown in FIG. 2, 1 indicates a video codec (coder decoder) for coding and decoding video data. 2 indicates an audio codec for coding and decoding audio data. 3 indicates an additional information and control information processing unit for performing the sending and receiving processing for a group of additional information and control information relating to a communication service. The sending and receiving processing is, for example, performed in the additional information and control information processing unit 3 for control information of a multi-point TV meeting held among members placed at many points. 4 indicates a multiplexing and demultiplexing unit for performing multiplexing and demultiplexing processing for multimedia information. The multimedia information is obtained by multiplexing the video data, the audio data and the like. 5a indicates a transmission interface unit for functioning as an interface with the communication network P on a communication channel of the multimedia information. 5b indicates a transmission interface unit for functioning as an interface with the communication network P on a communication channel of the group of additional information and control information. 6 indicates a call establishing control unit for establishing a communication channel of the multimedia information, performing a disconnection from the communication channel of the multimedia information, establishing a communication channel of the group of additional information and control information and performing a disconnection from the communication channel of the group of additional information and control information.

In the configuration of the communication service unit Q shown in FIG. 2, 51a to 51n indicate a plurality of transmission interface units for performing multimedia multi-point communication with the communication terminals A to N. 7a to 7n indicate a plurality of multiplexing and demultiplexing units, corresponding to the transmission interface units 51a to 51n respectively, for respectively performing multiplexing and demultiplexing processing for the multimedia information. 8 indicates a multimedia processing unit for performing media processing, which is appropriate to the communication terminals A to N connected to the communication service unit Q through the communication network P, for media data demultiplexed in each of the multiplexing and demultiplexing units 7a to 7n. For example, the selection of a picture of a speaker or audio mixing processing is performed for the media data in the multimedia processing unit 8. 52a to 52n indicate a plurality of transmission interface units for performing the communication of the group of additional information and control information relating to the communication service with the communication terminals A to N. Next, an operation will be described below.

In this embodiment, as an example, the communication terminal A performs a call control for the communication service unit Q and establishes a communication channel, and the multimedia multi-point communication is performed between the communication terminal A and a group of other communication terminals of many points.

An operation of the communication terminal-A is initially described with reference to FIG. 2.

In cases where the call establishing control unit 6 of the communication terminal A performs the multimedia multi-point communication of multimedia information and the multimedia multi-point communication of a group of additional information and control information with the communication service unit Q, the call establishing control unit 6 sends a call to the communication service unit Q through the transmission interface unit 5a in a bearer type appropriate to the multimedia multi-point communication, the call establishing control unit 6 establishes a communication channel appropriate to the multimedia multi-point communication, the call establishing control unit 6 sends a call to the communication service unit Q through the transmission interface unit 5b in a bearer type appropriate to the group of additional information and control information, and the call establishing control unit 6 establishes another communication channel appropriate to the group of additional information and control information.

Thereafter, the multi-point communication of multimedia information is performed between the communication terminal A and the communication service unit Q by sending video data and audio data denoting multimedia information as multiplexed data on the established communication channel from the video codec 1 and the audio codec 2 of the communication terminal A to the communication service unit Q through the multiplexing and demultiplexing unit 4 and the transmission interface unit 5a. Also, the multi-point communication of a group of additional information and control information is performed between the communication terminal A and the communication service unit Q by sending the group of additional information and control information on the other established communication channel from the additional information and control information processing unit 3 of the communication terminal A to the communication service unit Q through the transmission interface unit 5b. Here, in cases where the multi-point communication of multimedia information and the multi-point communication of a group of additional information and control information are performed between each of the communication terminals B to N and the communication service unit Q, the multi-point communications are performed in the same manner as those performed in the communication terminal A. Also, because a data amount of the multimedia information transmitted on the communication channel established between the communication terminal A and the communication service unit Q in the multi-point communication of the multimedia information differs from that of the group of additional information and control information transmitted on the other communication channel established between the communication terminal A and the communication service unit Q in the multi-point communication of the group of additional information and control information, a communication channel having both a channel capacity appropriate to a bit rate required in the communication of information and a band appropriate to the information is selected and established.

Next, an operation of the communication service unit Q is described with reference to FIG. 2.

When a call of the multimedia multi-point communication sent from one communication terminal A,—, or N is received in the corresponding transmission interface unit 51a,—, or 51n through the communication network P, the call receiving processing is performed in the call establishing control unit 10, and a communication channel of multimedia information is established in the call establishing control unit 10. Also, when a call of a group of additional information and control information sent from the communication terminal A,—, or N is received in the corresponding transmission interface unit 52a,—, or 52n, the call receiving processing is performed in the call establishing control unit 10, and a communication channel for a group of additional information and control information is established in the call establishing control unit 10.

Thereafter, in the corresponding transmission interface unit 51a,—, or 51n, the multiplexed data denoting multimedia information is received through the communication channel for multimedia information established by the call establishing control unit 6 of the communication terminal A,—, or N and is output to the corresponding multiplexing and demultiplexing unit 71a,—, or 71n. In the corresponding multiplexing and demultiplexing unit 71a,—, or 71n, the multiplexed data is demultiplexed to video data and audio data denoting media data, and the media data is output to the multimedia processing unit 81.

In the multimedia processing unit 81,the media processing appropriate to the communication terminals A to N is performed for the media data to produce processed media data. For example, the selection of a picture of a speaker or audio mixing processing is performed for the media data. Thereafter, the multi-point communication of multimedia information is performed on the communication channel for multimedia information established by the call establishing control unit 10 between the communication service unit Q and each of the communication terminals A to N by sending the processed media data to the communication terminals A to N through the multiplexing and demultiplexing units 7a to 7n and the transmission interface units 51a to 51n.

Also, in the corresponding transmission interface unit 52a,—, or 52n, a group of additional information and control information is received through the communication channel for a group of additional information and control information established by the call establishing control unit 6 of the communication terminal A,—, or N and is output to the additional information and control information processing unit 9. In the additional information and control information processing unit 9, prescribed processing is performed according to the group of additional information and control information to produce control data. The processing is, for example, performed according to control information of a multi-point TV meeting. Thereafter, communication is performed between the communication service unit Q and each of the communication terminals A to N by sending the control data to the communication terminals A to N through the transmission interface units 52a to 52n by using the communication channel for a group of additional information and control information established by the call establishing control unit 10.

In the explanation of the first embodiment, the communication channel for multimedia information and the communication channel for a group of additional information and control information are established in each of the communication terminals A to N. However, it is applicable that a plurality of communication channels can be established in each of the communication terminals A to N.

As is described above, in the first embodiment, the multi-point communication between one communication terminal A,—, or N and each of the other communication terminals A to N is performed by using a communication channel appropriate to characteristics of multimedia information and a communication channel appropriate to characteristics of a group of additional information and control information, and a multi-point communication service is received in each of the communication terminals A to N. Accordingly, the multi-point communication can be performed at high efficiency.

Also, it is not required to control the multi-point communication by sharing a band of a communication channel between the communication of multimedia information and the communication of a group of additional information and control information. Accordingly, the multi-point communication can be performed at high efficiency.

### EMBODIMENT 2

Next, a second embodiment of the present invention will be described.

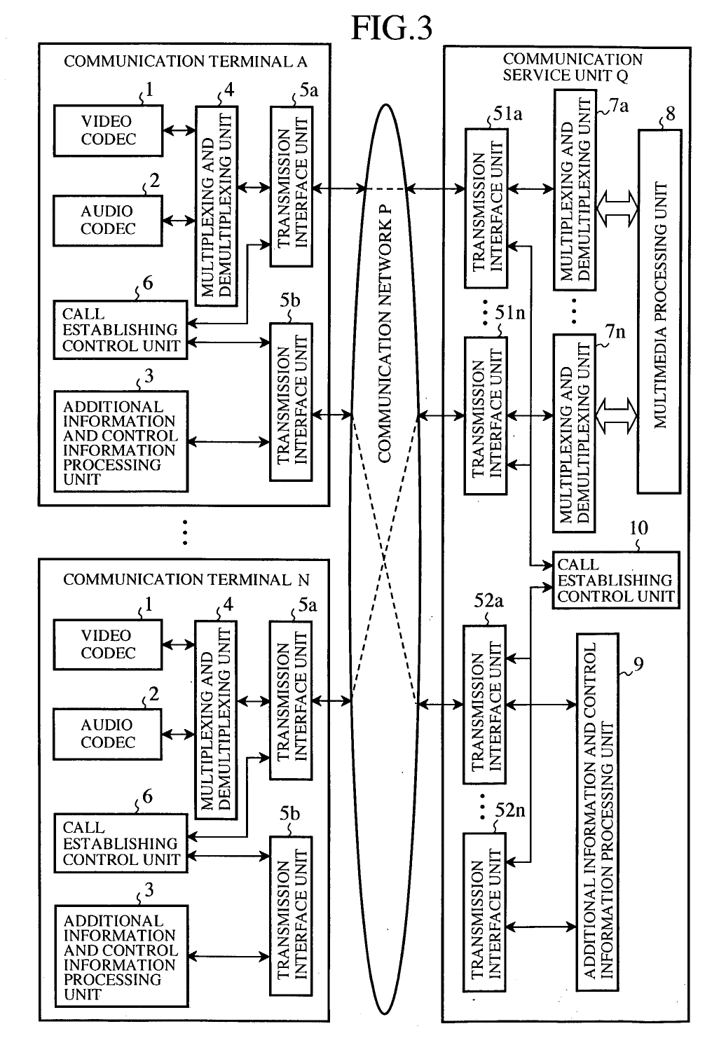

FIG. 3 is a view showing the configuration of a multimedia multi-point communication system adopting a multi-point communication method according to a second embodiment of the present invention. The constituent elements, which are the same as those of the multimedia multi-point communication system shown in FIG. 2, are indicated by the same reference numerals as those of the constituent elements shown in FIG. 2, and additional description of those constituent elements is omitted.

Next, an operation will be described below.

In a multimedia multi-point communication system according to a second embodiment, the establishment of the communication channel for multimedia information is performed in each of the communication terminals A to N in a band guarantee type audio visual (AV) bearer or in an unlimited digital (UD) bearer, and the multi-point communication is performed though the communication service unit Q.

Also, in the communication between the communication service unit Q and a communication terminal not requiring a group of additional information and control information or between the communication service unit Q and a communication terminal having no processing performance of a group of additional information and control information, the communication channel for a group of additional information and control information is not established. In contrast, a communication channel for a group of additional information and control information is established in a packet bearer such as information amount accounting between the communication service unit Q and a communication terminal requiring a group of additional information and control information, and the communication of the group of additional information and control information is performed. Here, in case of the multimedia multi-point communication system shown in FIG. 3, the communication terminal A requires a group of additional information and control information, the communication terminal A sends a call to the communication service unit Q through the transmission interface unit 5b in a bearer appropriate to a group of additional information and control information, and a communication channel for a group of additional information and control information is established in the communication terminal A. In contrast, the communication terminal N does not require a group of additional information and control information or does not have the processing performance of a group of additional information and control information. In this case, the communication terminal N does not send a call to the communication service unit Q through the transmission interface unit 5b in a bearer appropriate to a group of additional information and control information, and a communication channel for a group of additional information and control information is not established in the communication terminal N.

Therefore, a group of additional information and control information can be provided for a user requiring a group of additional information and control information, and a group of additional information and control information is not provided for a user not requiring a group of additional information and control information.

In the second embodiment, a user not requiring a group of additional information and control information is considered as an example, and a communication channel for a group of additional information and control information is not established for the user. However, the present invention is not limited to this case. For example, only accounting information is transmitted as a group of additional information and control information, or only the data communication of a group of additional information and control information is performed. In this case, it is preferable that no communication channel for multimedia information be established but only the communication channel for a group of additional information and control information be established. In this establishment, because it is not required to establish a communication channel for multimedia information, the communication channels can be efficiently used.

As is described above, in the second embodiment, in the same manner as in the first embodiment, multimedia information is transmitted by using a communication channel appropriate to characteristics of the multimedia information, and a group of additional information and control information is transmitted by using a communication channel appropriate to characteristics of the group of additional information and control information. Therefore, it is not required to control the multi-point communication by sharing a communication channel band between the communication of multimedia information and the communication of a group of additional information and control information and by using the shared communication channel band. Accordingly, the multi-point communication can be performed at high efficiency.

In particular, in the second embodiment, because no communication channel for a group of additional information and control information is established for a communication terminal of a user not requiring a group of additional information and control information, the communication channels can be efficiently used.

### EMBODIMENT 3

Next, a multi-point communication method according to a third embodiment of the present invention will be described with reference to the multimedia multi-point communication system shown in FIG. 2. Because the multimedia multi-point communication system shown in FIG. 2 is described in the first embodiment, additional description of the constituent elements indicated by the reference numerals is omitted.

Next, an operation will be described below.

In the multimedia multi-point communication system of the third embodiment, the establishment of the communication channel for multimedia information is performed in the band guarantee type audio visual (AV) bearer or in the unlimited digital (UD) bearer, and the multi-point communication of multimedia information is performed between each of the communication terminals A to N and the communication service unit Q though the communication network P. Also, the establishment of the communication channel for a group of additional information and control information is performed in a band non-guarantee type packet bearer, and the multi-point communication of a group of additional information and control information is performed between each of the communication terminals A to N and the communication service unit Q.

Therefore, in the multi-point communication performed between each of the communication terminals A to N and the communication service unit Q, in case of the communication of multimedia information, the multi-point communication is performed while always guaranteeing a band of the communication channel. In contrast, in case of the communication of a group of additional information and control information, a band of the communication channel is not guaranteed, and there is probability that the multi-point communication on the communication channel is not performed according to the congestion condition of the communication channel. However, in this case, the multi-point communication of multimedia information normally required to be transmitted in real time can be preferentially performed.

Here, in the third embodiment, a band guarantee type communication channel is used for a communication channel for the transmission of multimedia information, and a band non-guarantee type communication channel is used for a communication channel for the transmission of a group of additional information and control information. However, the present invention is not limited to this case. For example, in cases where the priority or a degree of importance of a group of additional information and control information is higher than that of multimedia information, or in cases where the transmission in real time is required, it is applicable that a band non-guarantee type communication channel be used for a communication channel for the transmission of multimedia information and a band guarantee type communication channel be used for the transmission of a group of additional information and control information.

As is described above, in the third embodiment, multimedia information or a group of additional information and control information is transmitted by using a communication channel established in a band guarantee type packet bearer or in a band non-guarantee type packet bearer appropriate to characteristics of the multimedia information or the group of additional information and control information. Therefore, in the same manner as in the first embodiment, it is not required to control the multi-point communication by sharing a band of a communication channel between the communication of multimedia information and the communication of a group of additional information and control information and by using the shared communication channel. Accordingly, the multi-point communication can be performed at high efficiency.

### EMBODIMENT 4

Next, a multi-point communication method according to a fourth embodiment of the present invention will be described. Because the configuration of the multimedia multi-point communication system adopting the multi-point communication method of the fourth embodiment is the same as that shown in FIG. 2 and because the configuration is described in the first embodiment, the same reference numerals as those shown in FIG. 2 are used in a following operation description, and additional description of the constituent elements indicated by the reference numerals is omitted.

Next, an operation will be described below.

In the multimedia multi-point communication system of the fourth embodiment, in cases where the communication channel for multimedia information is used for a two-way information transmission between each of the communication terminals A to N and the communication service unit Q, a communication protocol appropriate to the two-way communication is selected in each of the communication terminals A to N, and the multi-point communication of multimedia information is performed in the selected communication protocol. Also, in cases where the communication channel for multimedia information is used for a one-way information transmission from the communication service unit Q to each of the communication terminals A to N, a communication protocol appropriate to the one-way communication is selected and used in the communication service unit Q, and the multi-point communication of multimedia information is performed in the selected communication protocol. Also, it is applicable that the selection or alternation of a communication protocol be performed during the multi-point communication.

As is described above, in the fourth embodiment, multimedia information is transmitted by using a communication channel appropriate to characteristics of the multimedia information, and a group of additional information and control information is transmitted by using a communication channel appropriate to characteristics of the group of additional information and control information. Therefore, it is not required to control the multi-point communication by sharing a band of a communication channel and by using the shared communication channel. Accordingly, the multi-point communication can be performed at high efficiency.

In particular, in the fourth embodiment, the multi-point communication of the multimedia information is performed by using a communication channel based on a communication protocol appropriate to the two-way communication or a communication channel based on a communication protocol appropriate to the one-way communication. Therefore, the communication channel appropriate to characteristics of the multimedia information is used, and the communication channel appropriate to characteristics of the group of additional information and control information is used. Accordingly, the communication efficiency can be improved.

### EMBODIMENT 5

Next, a multi-point communication method according to a fifth embodiment of the present invention will be described.

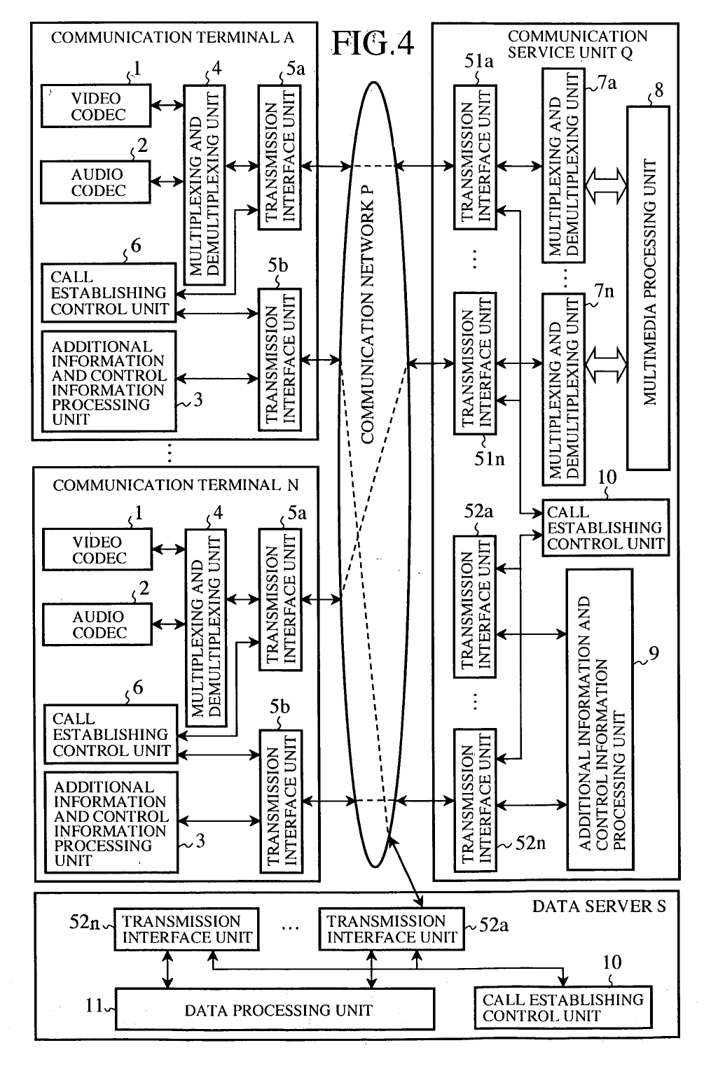

FIG. 4 is a view showing the configuration of a multimedia multi-point communication system adopting a multi-point communication method according to a fifth embodiment of the present invention.

The multimedia multi-point communication system shown in FIG. 4 can be obtained by adding a data server S to the multimedia multi-point communication system shown in FIG. 2. A data distribution service is performed in the data server S. The constituent elements, which are the same as those of the multimedia multi-point communication system shown in FIG. 2, are indicated by the same reference numerals as those of the constituent elements shown in FIG. 2, and additional description of those constituent elements is omitted. In the data server S shown in FIG. 4, 52a to 52n indicate a plurality of transmission interface units for performing the data communication of a group of additional information and control information with each of the communication terminals A to N. 10 indicates a call establishing control unit for performing the establishing processing to establish a communication channel of the data communication performed through each of the transmission interface units 51a to 51n. 11 indicates a data processing unit for performing the data sending and receiving processing for a group of additional information and control information.

Next, an operation will be described below.

In this embodiment, the communication terminal A sends a call to the communication service unit Q through the communication network P to establish a communication channel, the communication terminal A sends a call to the data server S through the communication network P to establish another communication channel, and the multi-point communication of multimedia information and the data communication of a group of additional information and control information are performed. An example of this case will be described.

An operation of the communication terminal A is initially described with reference to FIG. 4.

In cases where the call establishing control unit 6 of the communication terminal A performs both the multimedia multi-point communication of multimedia information and the data communication of a group of additional information and control information, the call establishing control unit 6 sends a call of a communication channel to the communication service unit Q in a bearer appropriate to the multimedia multi-point communication of multimedia information, and a communication channel for multimedia information is established. Also, the call establishing control unit 6 sends a call of a communication channel to the data server S in a bearer appropriate to the data communication of a group of additional information and control information, and a communication channel for a group of additional information and control information is established.

Thereafter, the video codec 1 and the audio codec 2 performs the multimedia multi-point communication with the communication service unit Q through the multiplexing and demultiplexing unit 4 and the transmission interface unit 5a, and the additional information and control information processing unit 3 performs the data communication with the data server S through the transmission interface unit 5b.

Here, a plurality of communication channels are established in the communication terminal N shown in FIG. 4 in the same manner as in the communication terminals A to N shown in FIG. 2. In the communication terminal N, a communication channel for the communication with the communication service unit Q is established in a bearer appropriate to the multi-point communication of multimedia information to transmit multimedia information such as video data and audio data to the communication service unit Q through the transmission interface unit 5a. Also, in the communication terminal N, a communication channel for the communication with the communication service unit Q is established in a bearer appropriate to a group of additional information and control information to transmit a group of additional information and control information to the communication service unit Q through the transmission interface unit 5b. Thereafter, the multi-point communication of multimedia information with each of the other communication terminals is performed through the communication service unit Q, and the multi-point communication of a group of additional information and control information with each of the other communication terminals is performed through the communication service unit Q.

Next, an operation of the communication service unit Q will be described below.

When a call of multimedia information sent from the communication terminal A and a call of multimedia information sent from the communication terminal N are received in the corresponding transmission interface units 51a and 51n of the communication service unit Q respectively, the call establishing control unit 10 of the communication service unit Q performs the call receiving processing for the calls to establish the communication channel for the multimedia multi-point communication, a communication channel for multimedia information with the communication terminal A is established, and a communication channel for multimedia information with the communication terminal N is established. Also, when a call of a group of additional information and control information sent from the communication terminal N is received in the corresponding transmission interface unit 52n different from the corresponding transmission interface unit 52a, the call establishing control unit 10 performs the call receiving processing for the call to establish the communication channel for a group of additional information and control information, and a communication channel for a group of additional information and control information with the communication terminal N is established.

Thereafter, in the multimedia processing unit 8 of the communication service unit Q, because the communication channel with each of the communication terminals A and N among the communication terminals A to N is established, the media processing corresponding to the communication terminals A and N is performed. In the example shown in FIG. 4, the multimedia multi-point communication with the communication terminal A is performed on the communication channel for multimedia information through the transmission interface unit 51a and the multiplexing and demultiplexing unit 7a, and the multimedia multi-point communication with the communication terminal N is performed on the communication channel for multimedia information through the transmission interface unit 51n and the multiplexing and demultiplexing unit 7n. Also, in the additional information and control information processing unit 9, the multi-point communication of a group of additional information and control information with the communication terminal N is performed on the communication channel for a group of additional information and control information through the transmission interface unit 52n.

Next, an operation of the data server S will be described below. In the call establishing control unit 10 of the data server S, prescribed processing is performed for a call sent from the communication terminal A through the transmission interface unit 52a, and a communication channel for a group of additional information and control information is established. Thereafter, in the data processing unit 11, the data processing corresponding to the communication terminal A is performed, and the data communication of a group of additional information and control information is performed on the established communication channel between the data server S and the communication terminal A through the transmission interface unit 52a.

Here, in the fifth embodiment, the communication channel for multimedia information is established to connect the communication terminal A with the communication service unit Q, the communication channel for a group of additional information and control information is established to connect the communication terminal A with the data server S, and this example is described. However, the present invention is not limited to this example. For example, in cases where a communication channel for multimedia information is established in a remarked communication terminal for the multi-point communication between the remarked communication terminal and the communication service unit Q so as to make the remarked communication terminal perform the multi-point communication with each of a plurality of other communication terminals through the communication service unit Q, it is applicable that a communication channel for a group of additional information and control information be established in the remarked communication terminal for the communication between the remarked communication terminal and a specific communication service unit different from the communication service unit Q to connect the remarked communication terminal with each of a plurality of other communication terminals connected with the specific communication service unit through a communication line. In this case, multimedia information and/or a group of additional information and control information in the data communication can be transmitted in the multi-point communication between the remarked communication terminal and each of the other communication terminals or can be transmitted between the remarked communication terminal and a group of other communication terminals relating to each other in another multi-point communication, and the multi-point communication through the communication service unit Q and the multi-point communication through the specific communication service unit different from the communication service unit Q can be simultaneously performed in the remarked communication terminal.

As is described above, in the fifth embodiment, in the same manner as in the first embodiment, the communication channel appropriate to characteristics of multimedia information is established to perform the multi-point communication of the multimedia information, and the communication channel for a group of additional information and control information is established to perform the multi-point communication of the group of additional information and control information. Therefore, it is not required to control the multi-point communication by sharing a band of a communication channel and by using the shared communication channel. Accordingly, the multi-point communication can be performed at high efficiency.

In particular, in the fifth embodiment, the communication channel for the communication of multimedia information is established to connect the communication terminal A with the communication service unit Q, the communication channel for a group of additional information and control information is established to connect the communication terminal A with the data server S. Therefore, the communication terminal A is simultaneously connected with both the communication service unit Q and the data server S different from each other. Accordingly, the use efficiency of a plurality of communication channels established to connect each of the communication terminals A to N with each of the communication service unit Q and the data server S can be improved.

### INDUSTRIAL APPLICABILITY

As is described above, the multi-point communication method according to the present invention is appropriate to the multi-point communication in which the communication of multimedia information and the communication of a group of additional information and control information are performed at high efficiency by using a protocol appropriate to multimedia information and a protocol appropriate to a group of additional information and control information respectively.

What is claimed is:

1. A multi-point communication method, in which a multi-point communication service is provided for a plurality of communication terminals through a multi-point communication service unit, comprising the steps of:
establishing a communication channel corresponding to contents of first transmitted information between each of the communication terminals and the multi-point communication service unit; and
establishing another communication channel corresponding to contents of second transmitted information different from the contents of the first transmitted information between each of the communication terminals and the multi-point communication service unit.

2. A multi-point communication method according to claim 1, further comprising the step of:
using a plurality of communication transmission services, which are provided by a communication network and are different from each other, in each communication terminal through the communication channels established between the communication terminal and the multi-point communication service unit.

3. A multi-point communication method according to claim 1, wherein the number of communication channels established between one communication terminal and the multi-point communication service unit differs from the number of communication channels established between another communication terminal and the multi-point communication service unit.

4. A multi-point communication method according to claim 1, wherein a plurality of communication channels are established between each communication terminal and the multi-point communication service unit, one communication channel is used for the transmission of multimedia coded information, and another communication channel is used for the transmission of a group of additional information and control information.

5. A multi-point communication method according to claim 4, wherein the communication channel used for the transmission of multimedia coded information is formed of a band guarantee type communication channel, and the communication channel used for the transmission of a group of additional information and control information is formed of a band non-guarantee type communication channel.

6. A multi-point communication method according to claim 1, further comprising the steps of:
using one of the communication channels for the transmission of multimedia information;
using a communication protocol for the communication channel used for the transmission of multimedia information in a case where the communication channel for the transmission of multimedia information is used for a two-way information transmission between one communication terminal and another communication terminal; and
using another communication protocol for the communication channel used for the transmission of multimedia information in a case where the communication channel for the transmission of multimedia information is used for a one-way information transmission from the multi-point communication service unit to one communication terminal.

7. A multi-point communication method according to claim 6, further comprising the step of:
dynamically altering one of the communication protocols for the communication channel used for the transmission of multimedia information to the other communication protocol during the communication of the multimedia information.

8. A multi-point communication method according to claim 1, further comprising the steps of:
establishing a specific communication channel used for the communication between a remarked communication terminal and another communication terminal or a communication server different from the multi-point communication service unit;
transmitting a group of additional information and control information on the specific communication channel established between the remarked communication terminal and the other communication terminal or the communication server different from the multi-point communication service unit; and
transmitting both other additional information and other control information on one communication channel established between one of the communication terminals and the multi-point communication service unit.
